(19) United States
(12) Patent Application Publication
(10) Pub. No.: US 2025/0023409 A1
(43) Pub. Date: Jan. 16, 2025

(54) COMPRESSOR MOTOR AND COMPRESSOR INCLUDING COMPRESSOR MOTOR

(71) Applicant: LG Electronics Inc., Seoul (KR)

(72) Inventors: Jinwook REU, Seoul (KR); Daekyu Jang, Seoul (KR); Kyungho Ha, Seoul (KR); Hyeonnyeong Choi, Seoul (KR)

(21) Appl. No.: 18/586,836

(22) Filed: Feb. 26, 2024

(30) Foreign Application Priority Data
Jul. 12, 2023 (KR) 10-2023-0090543

(51) Int. Cl. H02K 1/278; H02K 5/10

(52) U.S. Cl. CPC H02K 1/278; H02K 5/10; H02K 2213/03

(57) ABSTRACT

A compressor motor and a compressor including a compressor motor are provided. The compressor motor may include a stator and a rotor. The rotor may include a rotor core and a plurality of magnets disposed on a radially outer surface of the rotor core. The rotor core may include a plurality of seating grooves in which the plurality of magnets is respectively seated, and a plurality of protrusions that protrudes radially outward between the plurality of seating grooves. The magnet may slide axially between adjacent protrusions of the plurality of protrusions, an inner surface of the magnet may be seated in the seating groove, and at least a portion of a side surface of the magnet may contact a side surface of the protrusion. The side surface of the magnet may extend and protrude further radially outward than the side surface of the protrusion, and a fixing layer may be disposed in at least a partial area radially outward of the outer peripheral surface of the protrusion.

### CROSS-REFERENCE TO RELATED APPLICATION(S)

This application claims the benefit of Korea Patent Application No. 10-2023-0090543, filed in Korea on Jul. 12, 2023, which is incorporated herein by reference for all purposes as if fully set forth herein.

### BACKGROUND

### 1. Field

A compressor motor and a compressor including a compressor motor are disclosed herein.

### 2. Background

In general, a compressor refers to a device that is configured to receive power from a power generator, such as a motor or a turbine, and compress a working fluid, such as air or refrigerant. More specifically, compressors are widely used in various industries or home appliances, such as for a steam compression refrigeration cycle (hereinafter, referred to as “refrigeration cycle”).

Compressors may be classified into a reciprocating compressor, a rotary compressor, and a scroll compressor depending on a method of compressing the fluid. The reciprocating compressor uses a method in which a compression space is formed between a piston and a cylinder, and the piston linearly reciprocates to compress a fluid. The rotary compressor uses a method of compressing a fluid by a roller that eccentrically rotates inside of a cylinder. The scroll compressor uses a method of compressing a fluid by engaging and rotating a pair of spiral scrolls.

The reciprocating compressor also uses a method in which a crankshaft is coupled to a rotor of a motor, a connecting rod is coupled to the crankshaft, and the piston coupled to the connecting rod compresses fluid while linearly reciprocating inside of the cylinder. Recently, among the reciprocating compressors, the use of linear compressors that uses a linear reciprocating motion without using the crankshaft is gradually increasing. The linear compressor has advantages in that it has less mechanical loss resulting from converting rotational motion into linear reciprocating motion, and thus, may improve efficiency of the compressor, and has a relatively simple structure.

FIG. 18 is a cross-sectional view of a motor according to the related art. Referring to FIG. 18, a reciprocating compressor according to the related art may use interior permanent magnet (IPM) motors 300 and 400 in which a magnet 420 is inserted into the rotor 400.

More specifically, the motors 300 and 400 may include a stator 300 including a stator portion 310 and a coil 320 wound around the stator portion 310, and a rotor 400 including a rotor core 410 disposed inside of the stator 300 and coupled to a shaft and a magnet 420 inserted into the rotor core 410. However, the IPM motor had a problem in that a motor excitation force increased and a back electromotive force decreased compared to a surface-mounted permanent magnet (SPM) motor in which a magnet is mounted on a surface of a rotor.

### BRIEF DESCRIPTION OF THE DRAWINGS

Embodiments will be described in detail with reference to the following drawings in which like reference numerals refer to like elements, and wherein:

FIG. 1 is a cross-sectional view of a compressor according to an embodiment;

FIG. 2 is a cross-sectional view of a motor according to an embodiment;

FIG. 3 is a perspective view of a rotor and a fixing member according to an embodiment;

FIG. 4 is a front view of a rotor and a fixing member according to an embodiment;

FIG. 5 is a plan view of a rotor and a fixing member according to an embodiment;

FIG. 6 is a bottom view of a rotor and a fixing member according to an embodiment;

FIG. 7 is a cross-sectional view, taken along line VII-VII′ of FIG. 4;

FIG. 8 is an enlarged view of a portion B of FIG. 7;

FIG. 9 is a cross-sectional view of a first protrusion according to an embodiment;

FIG. 10 is a cross-sectional view of a first protrusion and a second magnet according to an embodiment;

FIG. 11 is a cross-sectional view of a first protrusion, first and second magnets, and a fixing member according to an embodiment;

FIG. 12 is a graph illustrating a safety factor of a protrusion and a back electromotive force of a motor depending on a value obtained by dividing a distance between adjacent magnets by a minimum value of a width of the protrusion according to an embodiment;

FIGS. 13 to 15 are cross-sectional views of a first protrusion and first and second magnets according to an embodiment;

FIG. 16 is a graph illustrating a safety factor of a protrusion depending on a radial depth of a groove of the protrusion of a rotor core according to an embodiment;

FIG. 17 is a cross-sectional view of a first protrusion and first and second magnets according to an embodiment; and

FIG. 18 is a cross-sectional view of a motor according to the related art.

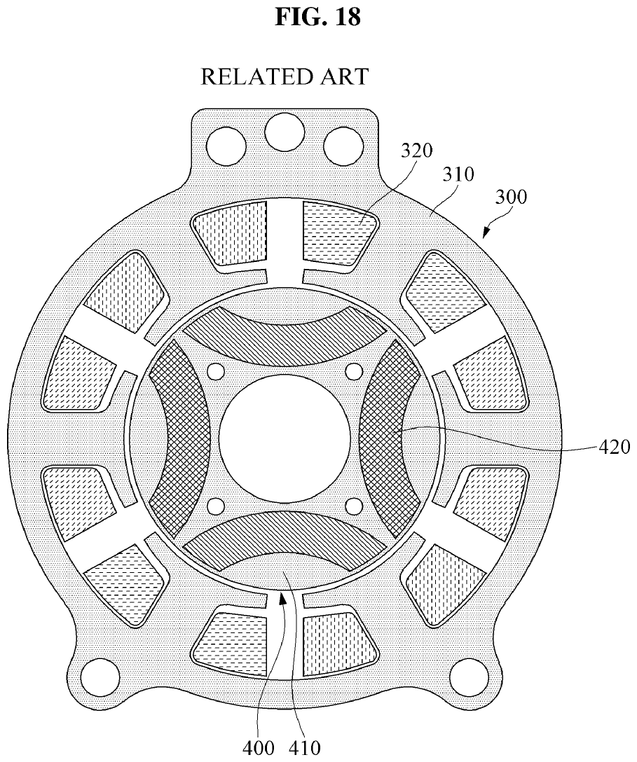

### DETAILED DESCRIPTION

Reference will now be made to embodiments, examples of which are illustrated in the accompanying drawings. Wherever possible, the same reference numbers will be used throughout the drawings to refer to the same or like parts.

It should be understood that when a component is described as being “connected to” or “coupled to” other component, it may be directly connected or coupled to the other component or intervening component(s) may be present.

It will be noted that a detailed description of known arts will be omitted if it is determined that description of the known arts may obscure embodiments. The accompanying drawings are used to help easily understand various technical features and it should be understood that embodiments presented herein are not limited by the accompanying drawings. As such, the embodiments should be understood to extend to any alterations, equivalents and substitutes in addition to those which are particularly set out in the accompanying drawings.

In addition, a term of “disclosure” may be replaced by terms such as document, specification, description, etc.

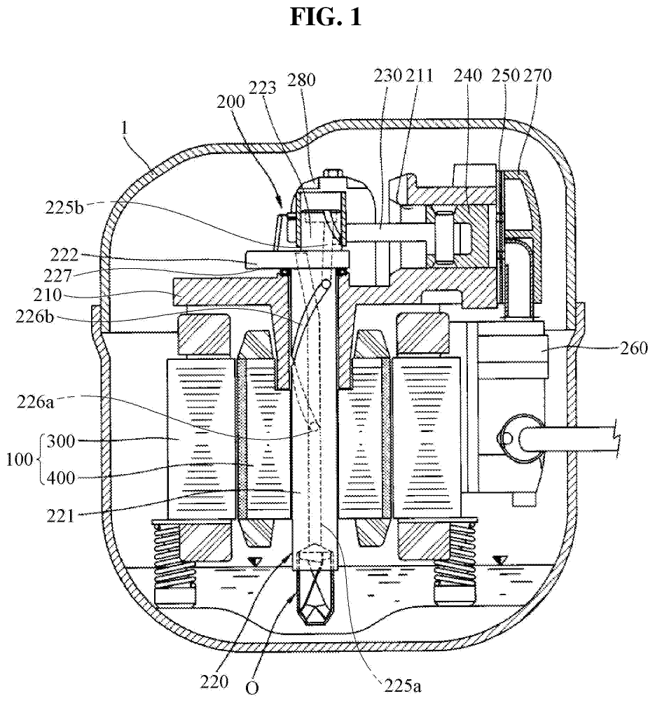

FIG. 1 is a cross-sectional view of a compressor according to an embodiment. Referring to FIG. 1, a compressor according to an embodiment may include a sealed container 1, a motor 100, and a compression unit 200.

The sealed container 1 may form an outer appearance of the compressor. The motor 100 and the compression unit 200 may be disposed in the sealed container 1.

The motor 100 may be installed inside of the sealed container 1 and may perform a rotational motion. The motor 100 may include a constant speed motor that performs only a normal rotation, a constant speed motor that can perform a normal rotation and a reverse rotation, or an inverter motor.

The motor 100 may include a stator 300 installed on a cylinder block 210 inside of the sealed container 1, and a rotor 400 rotatably installed inside of the stator 300.

The compression unit 200 may be installed on an upper side of the motor 100. The compression unit 200 may receive a rotational force of the motor 100 to compress a fluid, such as a refrigerant.

The compression unit 200 may include the cylinder block 210, a crankshaft 220, a connecting rod 230, a piston 240, a valve assembly 250, an intake muffler 260, a discharge cover 270, and a discharge muffler 280. The cylinder block 210 may include a cylinder 211 forming a compression space. The cylinder block 210 may be elastically supported by the sealed container 1.

The crankshaft 220 may be inserted into the cylinder block 210 and supported radially and axially. The crankshaft 220 may be coupled to the rotor 400 of the motor 100 to transmit the rotational force.

The connecting rod 230 may be rotatably coupled to the crankshaft 220. The connecting rod 230 may convert a rotational motion of the crankshaft 220 into a linear motion.

The piston 240 may be rotatably coupled to the connecting rod 230. The piston 240 may linearly reciprocate in the cylinder 211. The piston 240 may compress the refrigerant.

The valve assembly 250 may be coupled to a tip of the cylinder block 210. The valve assembly 250 may include an intake valve and a discharge valve. The valve assembly 250 may include an intake muffler 260 coupled to an intake side of the valve assembly 250, the discharge cover 270 coupled to a discharge side of the valve assembly 250, and the discharge muffler 280 that communicates with the discharge cover 270 and attenuates a discharge noise of the discharged refrigerant.

In the compressor, when power is applied to the stator 300 of the motor 100, the rotor 400 may rotate together with the crankshaft 220 due to an interaction force between the stator 300 and the rotor 400, and the connecting rod 230 coupled to a pin 223 of the crankshaft 220 may perform a turning motion. In this case, the compressor repeats a series of processes, in which the piston 240 coupled to the connecting rod 230 compresses the refrigerant while linearly reciprocating in the cylinder 211 to discharge the refrigerant to the discharge cover 270, and the refrigerant discharged to the discharge cover 270 is discharged in a refrigeration cycle via the discharge muffler 280.

An oil feeder O installed at a lower end of the crankshaft 220 may pump oil stored in an oil reservoir of the sealed container 1 while the crankshaft 220 rotates. The oil may be suctioned up through an oil passage of the crankshaft 220 and supplied to each sliding surface, while a portion of the oil may scatter from an upper end of the crankshaft 220 to cool the motor 100.

A configuration of the crankshaft 200 for suctioning up the oil stored in the oil reservoir of the sealed container 1 is as follows.

The crankshaft 220 may include a shaft 221 that is coupled to the rotor 400, inserted into a shaft hole of the cylinder block 210, and supported radially by the cylinder block 210, an eccentric mass 222 that is eccentrically formed in a fan shape or an eccentric circular flange shape at an upper end of the shaft 221 to form a plate-shaped extension, and the pin 223 which is formed on an upper surface of the eccentric mass 222 to be eccentric with respect to the shaft 221 and into which the connecting rod 230 is rotatably inserted. The shaft 221 may be configured such that a first journal bearing surface and a second journal bearing surface are formed at a predetermined interval on an outer peripheral surface corresponding to a journal bearing surface of the shaft hole.

From a lower end to the upper end of the shaft 221, a first oil passage 225a may be formed to extend axially or may be slightly inclined axially. From an upper end of the pin 223 to an upper portion of the shaft 221, a second oil passage 225b having a predetermined depth may be formed axially.

The first oil passage 225a and the second oil passage 225b may not communicate with each other.

In a middle of the first oil passage 225a, that is, in a portion corresponding to a lower half of the journal bearing surface of the shaft hole, a first oil outlet hole 226a may be formed to guide the oil to the second journal bearing surface of the crankshaft 220. A first oil groove 226b having a predetermined height from the first oil outlet hole 226a, that is, a predetermined inclination angle almost up to an end of the shaft hole may be formed in a spiral shape.

An oil inlet hole that communicates with the second oil passage 225b may be formed at an end of the first oil groove 226b. In a middle of the second oil passage 225b, that is, in a portion coupled to the connecting rod 230, a second oil outlet hole may be formed to guide the oil suctioned up through the second oil passage 225b to an outer peripheral surface. The oil pumped by the oil feeder O may be suctioned up through the first oil passage 225a, and a portion of the oil may be guided to the first oil groove 226b through the first oil outlet hole 226a.

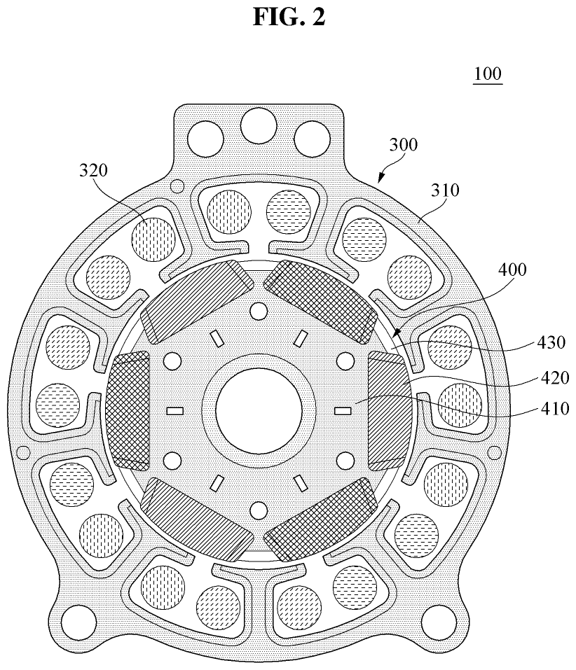

FIG. 2 is a cross-sectional view of a motor according to an embodiment. Referring to FIG. 2, the motor 100 according to an embodiment may include stator 300, rotor 400, and a fixing member or layer 430.

The stator 300 may be disposed in the sealed container 1. The stator 300 may include a stator portion 310 and a coil 320 wound around the stator portion 310.

The rotor 400 may be disposed inside of the stator 300. The rotor 400 may be coupled to the crankshaft 220. The rotor 400 may include a rotor core 410 disposed inside of the stator portion 310 and coupled to the crankshaft 220, a magnet 420 disposed on a radially outer surface of the rotor core 410, and the fixing member 430 that fixes the magnet 420 to the rotor core 410.

In one embodiment, the motor 100 may be a surface-mounted permanent magnet (SPM) motor in which the magnet 420 is mounted on the surface of the rotor 400. In this embodiment, the motor 100 is described using a 6-pole 9-slot motor as an example; however, embodiments are not limited thereto.

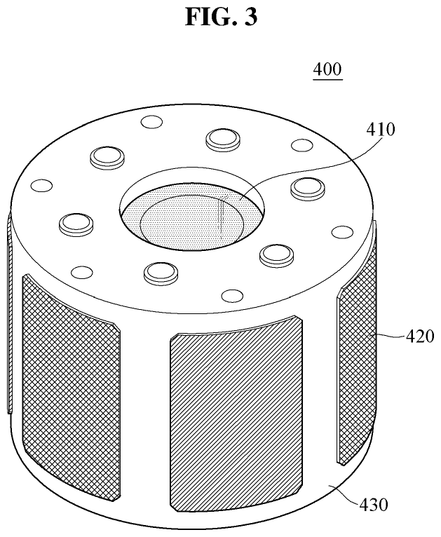

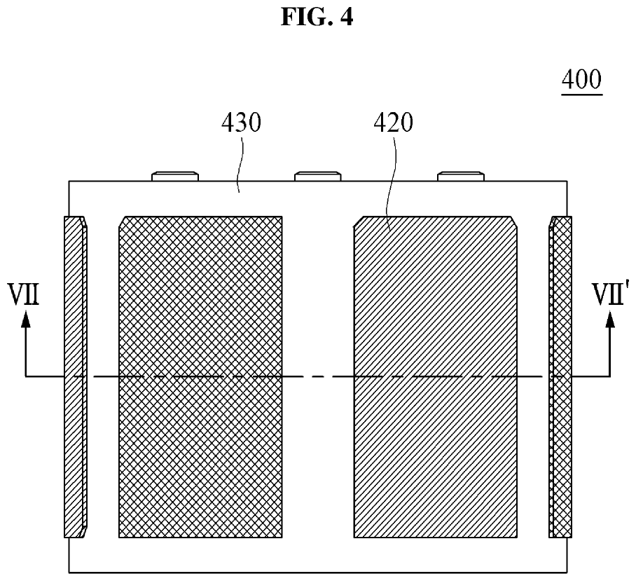

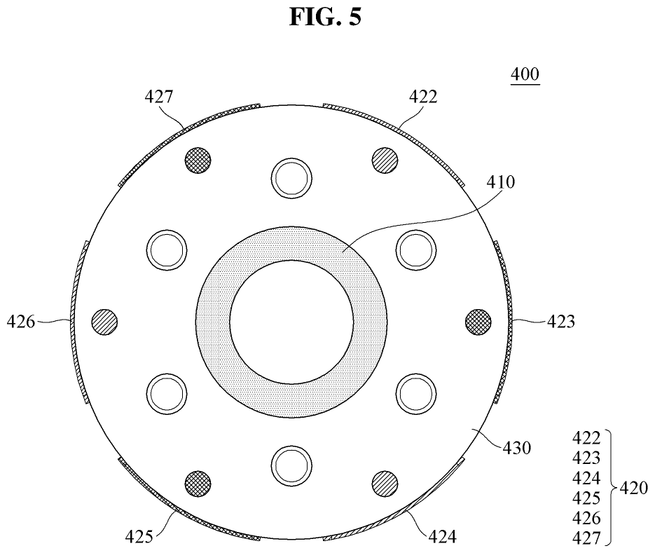

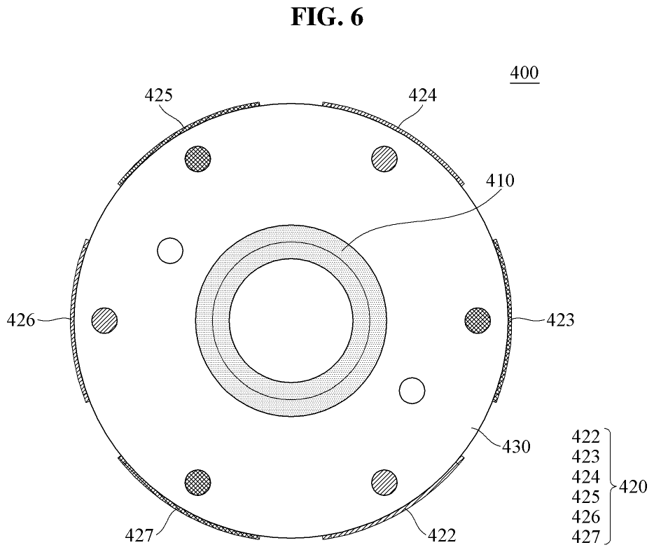

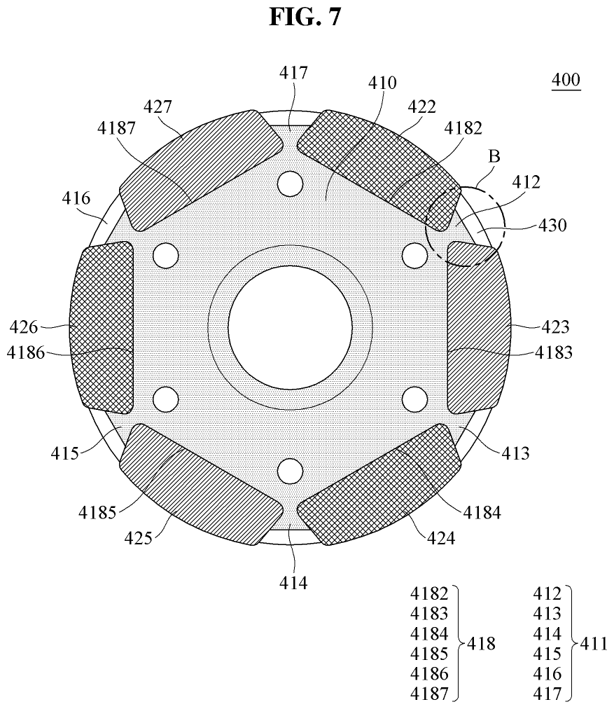

FIG. 3 is a perspective view of a rotor and a fixing member according to an embodiment. FIG. 4 is a front view of a rotor and a fixing member according to an embodiment. FIG. 5 is a plan view of a rotor and a fixing member according to an embodiment. FIG. 6 is a bottom view of a rotor and a fixing member according to an embodiment. FIG. 7 is a cross-sectional view, taken along line VII-VII′ of FIG. 4.

Referring to FIGS. 3 to 7, the rotor 400 according to an embodiment may include the rotor core 410 and the magnet 420. The rotor core 410 may be coupled to the crankshaft 220. The rotor core 410 may be disposed inside of the stator portion 310. The rotor core 410 may be formed in a cylindrical shape. The rotor core 410 may include seating groove(s) 418 and protrusion(s) 411. The rotor core 410 may be formed by axially stacking a plurality of magnetic steel plates.

The seating groove 418 may be formed to be concave radially inward on an outer surface of the rotor core 410. The magnet 420 may be disposed in the seating groove 418.

The seating groove 418 may include a plurality of seating grooves 4182, 4183, 4184, 4185, 4186, and 4187 that are spaced apart from each other in a circumferential direction. A plurality of magnets 422, 423, 424, 425, 426, and 427 may be respectively disposed in the plurality of seating grooves 4182, 4183, 4184, 4185, 4186, and 4187.

The plurality of seating grooves 4182, 4183, 4184, 4185, 4186, and 4187 may include first seating groove 4182, second seating groove 4183, third seating groove 4184, fourth seating groove 4185, fifth seating groove 4186, and sixth seating groove 4187. The first seating groove 4182, the second seating groove 4183, the third seating groove 4184, the fourth seating groove 4185, the fifth seating groove 4186, and the sixth seating groove 4187 may be understood as having a same shape. In this embodiment, the number of the plurality of seating grooves 4182, 4183, 4184, 4185, 4186, and 4187 is six, by way of example; however, embodiments are not limited thereto. For example, the number of seating grooves may be variously changed depending on the number of the plurality of magnets 422, 423, 424, 425, 426, and 427.

The protrusion 411 may protrude radially outward from the outer surface of the rotor core 410. The protrusion 411 may include a plurality of protrusions 412, 413, 414, 415, 416, and 417 disposed between the plurality of seating grooves 4182, 4183, 4184, 4185, 4186, and 4187. The plurality of protrusions 412, 413, 414, 415, 416, and 417 may be spaced apart from each other in the circumferential direction. The plurality of magnets 422, 423, 424, 425, 426, and 427 may be disposed between adjacent protrusions of the plurality of protrusions 412, 413, 414, 415, 416, and 417.

The plurality of protrusions 412, 413, 414, 415, 416, and 417 may include first protrusion 412, second protrusion 413, third protrusion 414, fourth protrusion 415, fifth protrusion 416, and sixth protrusion 417. The first protrusion 412, the second protrusion 413, the third protrusion 414, the fourth protrusion 415, the fifth protrusion 416, and the sixth protrusion 417 may be understood as having a same shape. In this embodiment, the number of the plurality of protrusions 412, 413, 414, 415, 416, and 417 is six, by way of example; however, embodiments are not limited thereto. For example, the number of protrusions may be variously changed depending on the number of the plurality of magnets 422, 423, 424, 425, 426, and 427.

The magnet 420 may be disposed on a radially outer surface of the rotor core 410. The magnet 420 may be disposed in the seating groove 418. The magnet 420 may slide axially between adjacent protrusions of the plurality of protrusions 412, 413, 414, 415, 416, and 417 and may be seated in the seating groove 418. Herein, the term “axial direction” (or axially) may be interpreted to mean a vertical direction with reference to FIG. 4.

The magnet 420 may include the plurality of magnets 422, 423, 424, 425, 426, and 427 that are spaced apart from each other in the circumferential direction. The plurality of magnets 422, 423, 424, 425, 426, and 427 may be respectively disposed in the plurality of seating grooves 4182, 4183, 4184, 4185, 4186, and 4187.

The plurality of magnets 422, 423, 424, 425, 426, and 427 may include first magnet 422, second magnet 423, third magnet 424, fourth magnet 425, fifth magnet 426, and sixth magnet 427. The first magnet 422, the second magnet 423, the third magnet 424, the fourth magnet 425, the fifth magnet 426, and the sixth magnet 427 may be understood as having a same shape. In this embodiment, the number of the plurality of magnets 422, 423, 424, 425, 426, and 427 is six, by way of example; however, the number of magnets may be variously changed depending on specifications of the stator 300.

A separate adhesive may not be interposed between the magnet 420 and the seating groove 418. That is, as the magnet 420 is slidably seated in the seating groove 418 and is fixed by the fixing member 430, the magnet 420 may be prevented from being detached from the rotor core 410. Hence, a safety factor of the rotor 400 may be improved while ease of assembly of the rotor 400 is improved.

The fixing member 430 may fix the magnet 420 to the rotor core 410. The fixing member 430 may surround an upper surface of the rotor core 410, a lower surface of the rotor core 410, and surfaces of the plurality of magnets 422, 423, 424, 425, 426, and 427 contacting the plurality of protrusions 412, 413, 414, 415, 416, and 417. The fixing member 430 may surround radially outer surfaces of the plurality of protrusions 412, 413, 414, 415, 416, and 417, and upper surfaces and lower surfaces of the plurality of protrusions 412, 413, 414, 415, 416, and 417. That is, the fixing member 430 may surround an entire area of the rotor core 410 and the magnet 420, except for central portions of the upper surface and the lower surface of the rotor core 410 and the surface of the magnet 420 disposed radially outward.

The fixing member 430 may be, for example, double-injected with the rotor 400. The rotor 400 may be, for example, insert-molded into the fixing member 430. The fixing member 430 may be, for example, injection molded. The fixing member 430 may be formed of a plastic material. The fixing member 430 may be formed of a resin material. The fixing member 430 may be formed of polybutylene terephthalate (PBT) material. With this structure, embodiments may prevent damage to the magnet 420 and the rotor core 410 by preventing the magnet 420 seated on the outer peripheral surface of the rotor core 410 from moving, and may prevent the magnet 420 from being detached from the rotor core 410. Further, embodiments may reduce manufacturing costs of the motor 100 and prevent performance degradation of the motor 100, compared to a method of modifying the magnet 420 and fixing it to the rotor core 410 or a method of fixing the magnet 420 to the rotor core 410 through an additional coupling member. In addition, embodiments may reduce an excitation force of the motor 100 and increase a back electromotive force of the motor 100.

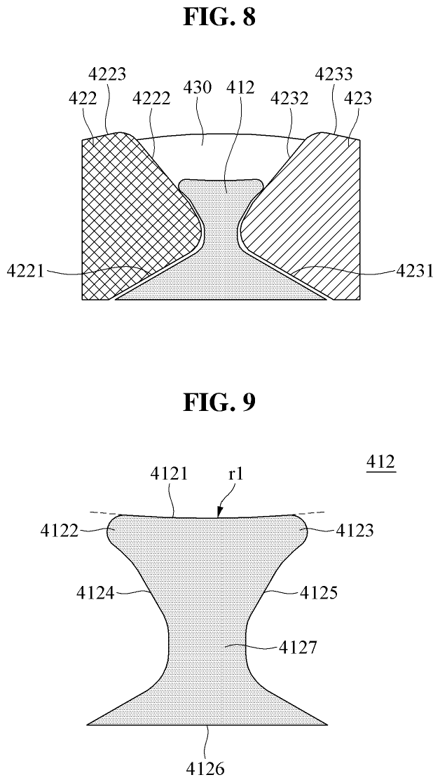

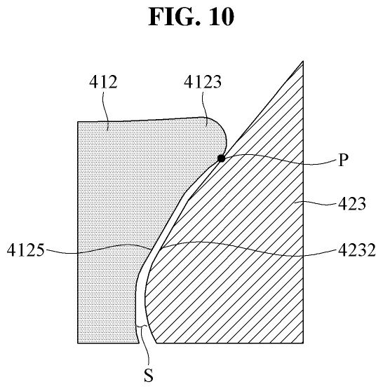

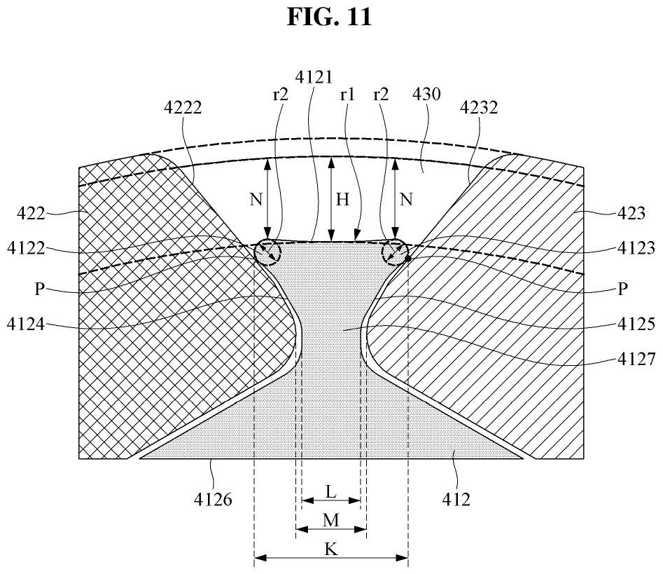

FIG. 8 is an enlarged view of a portion B of FIG. 7. FIG. 9 is a cross-sectional view of a first protrusion according to an embodiment. FIG. 10 is a cross-sectional view of a first protrusion and a second magnet according to an embodiment.

With reference to FIGS. 8 to 10, shapes of the protrusion 411, the magnet 420, and the fixing member 430 are described hereinafter. Hereinafter, the shapes are described by taking an area in which the first protrusion 412, the first magnet 422, and the second magnet 423 are disposed as an example, but it is obvious that it can be applied to an entire area of the rotor 400 and the fixing member 430.

An axial cross section of the magnet 420 may be formed in a trapezoidal shape. The magnet 420 may include four surfaces that extend axially. The four surfaces of the magnet 420 may include an inner surface 4221/4231 that faces radially inward, an outer surface 4223/4233 that is positioned opposite to the inner surface 4221/4231 and faces the outer peripheral surface of the rotor 400, and two side surfaces 4222/4232 that connect the inner surface 4221/4231 and the outer surface 4223/4233. The inner surfaces 4221 and 4231 of the magnet 420 may be seated in the seating groove 418. At least a portion of the side surfaces 4222 and 4232 of the magnet 420 may contact a first surface 4124 and a second surface 4125 of the protrusion 411.

An axial cross section of the protrusion 411 may be formed in an inverted trapezoidal shape to guide the magnet 420. The first protrusion 412 may be disposed between the first magnet 422 and the second magnet 423. The fixing member 430 may be disposed between the first magnet 422 and the second magnet 423.

An axial cross section of the first protrusion 412 may include a lower surface 4126 that contacts the radially outer surface of the rotor core 410, first and second surfaces 4124 and 4125 that extend radially outward from the lower surface 4126, guide portions 4122 and 4123 that extend from the first and second surfaces 4124 and 4125 and are formed at both ends of the first protrusion 412 on a radially outer side of the first protrusion 412, and an outer peripheral surface 4121 that connects the guide portions 4122 and 4123 and is disposed on the radially outer side of the first protrusion 412. The first and second surfaces 4124 and 4125 may be referred to as both sides of the first protrusion 412.

The guide portions 4122 and 4123 may be formed to be outwardly convex in the circumferential direction. More specifically, first guide portion 4122 disposed on a left or first side in FIGS. 8 to 10 may be formed to be convex as it extends toward the left side, that is, outside in the circumferential direction, and the second guide portion 4123 disposed on a right or second side in FIGS. 8 to 10 may be formed to be convex as it extends toward the right side, that is, outside in the circumferential direction. The guide portions 4122 and 4123 may have a second radius of curvature r2.

The first guide portion 4122 may be in contact with the first magnet 422. The first guide portion 4122 may be in contact with the first magnet 422 at one point, that is, contact point P. Except for the contact point P where the first guide portion 4122 and the first magnet 422 contact, the first protrusion 412 and the first magnet 422 may be in non-contact.

Further, the second guide portion 4123 may be in contact with the second magnet 423. The second guide portion 4123 may be in contact with the second magnet 423 at one point, that is, contact point P. Except for the contact point P where the second guide portion 4123 and the second magnet 423 contact, the first protrusion 412 and the second magnet 423 may be in non-contact. With this structure, embodiments may minimize a contact area of the magnet 420 and the protrusion 411 to prevent damage to the magnet 400 that occurs when assembling the rotor 400 and to improve ease of assembly of the rotor 400.

Referring to FIG. 10, a portion between the contact point P of the first protrusion 412, which contacts the second magnet 423 at the one point, and an area adjacent to the second seating groove 4183 may be formed to be concave toward the first side, that is, an inside of the first protrusion 412. Further, a portion between the contact point P of the second magnet 423, which contacts the first protrusion 412 at the one point, and an area adjacent to the second seating groove 4183 may be formed to be convex toward the first side, that is, the outside. That is, the second magnet 423 and the first protrusion 412 may become farther apart from each other as they extend radially inward from the contact point P. That is, based on the contact point P, a width of an area S between the second magnet 423 and the first protrusion 412 may gradually increase as it extends downward, that is, radially inward.

With this structure, embodiments may improve ease of assembly of the magnet 420 to the rotor 400 and compensate for product tolerances.

A width of the first protrusion 412 may gradually decrease as the first protrusion 412 extends radially inward from the guide portions 4122 and 4123, which are both ends in the circumferential direction. At least one area of the side surfaces 4222 and 4232 of the first and second magnets 422 and 423 may gradually increase as the side surfaces 4222 and 4232 extend radially inward, and an area between the side surfaces 4222 and 4232 and the inner surfaces 4221 and 4231 of the first and second magnets 422 and 423 may be formed to be outwardly convex. The concave shape of the first protrusion 412 and the convex shape of the first and second magnets 422 and 423 may be shapes that complement each other. With this structure, space efficiency of the rotor 400 may be improved.

That is, a distance between the first surface 4124 and the second surface 4125 may decrease as they extend radially inward from the outer peripheral surface 4121. When the first and second magnets 422 and 423 extend radially inward from an area where they are closest to each other, the distance between the first surface 4124 and the second surface 4125 may increase again.

An outer surface of the fixing member 430 may be formed to be radially outwardly convex. With this structure, a safety factor of the fixing member 430 may be improved. With respect to FIGS. 8 to 10, it can be interpreted that radially outward means in an upward direction, and radially inward means in a downward direction.

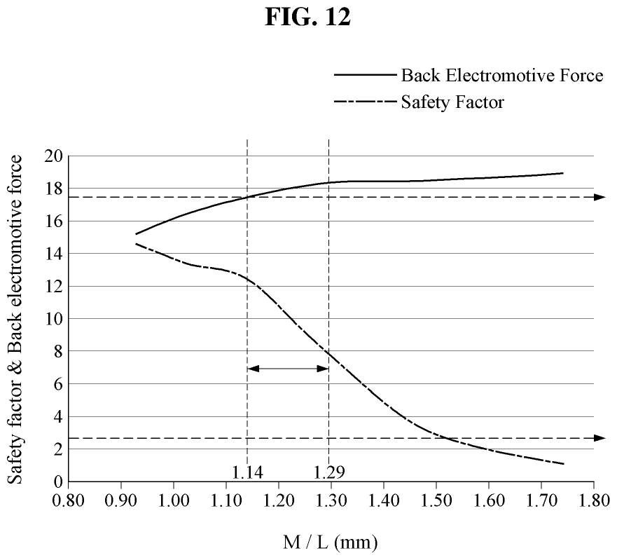

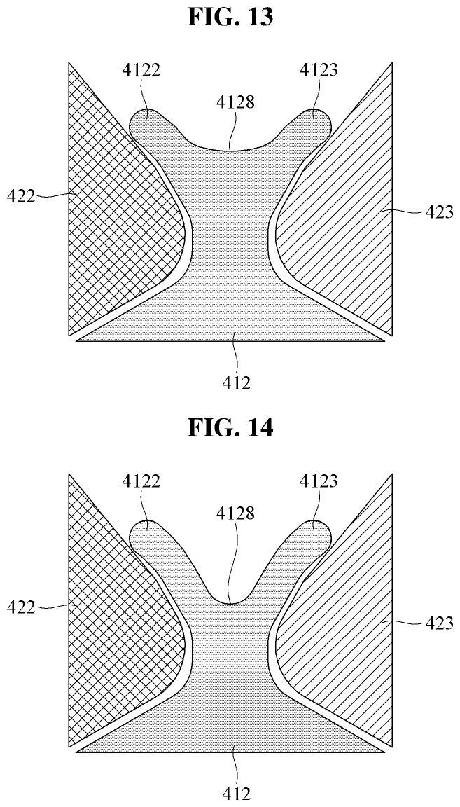

FIG. 11 is a cross-sectional view of a first protrusion, first and second magnets, and a fixing member according to an embodiment. FIG. 12 is a graph illustrating a safety factor of a protrusion and a back electromotive force of a motor depending on a value obtained by dividing a distance between adjacent magnets by a minimum value of a width of the protrusion according to an embodiment.

Referring to FIG. 11, the outer peripheral surface 4121 of the first protrusion 412 may be formed to be radially inwardly concave. The outer peripheral surface 4121 of the first protrusion 412 may have a first radius of curvature r1. More specifically, between the first magnet 422 and the second magnet 423, a thickness H of a central portion of the fixing member 430 may be greater than a thickness N of other portions. With this structure, a radial length of the fixing member 430 may increase, thereby improving a safety factor of the rotor 400.

An outer diameter (or lateral depth) of the fixing member 430 may be greater than an outer diameter (or lateral depth) of the first protrusion 412 and less than outer diameters (or radial depths) of the first and second magnets 422 and 423. More specifically, the side surfaces 4222 and 4232 of the first and second magnets 422 and 423 may extend and protrude further radially outward than the side surfaces 4124 and 4125 of the first protrusion 412, the fixing member 430 may be disposed in at least a partial area radially outward of the outer peripheral surface 4121 of the first protrusion 412, and the side surfaces 4222 and 4232 of the first and second magnets 422 and 423 may protrude further radially outward than an outer peripheral surface of the fixing member 430. With this structure, embodiments may prevent a reduction in output of the motor 100 by maintaining a constant gap between the magnet 420 and the stator portion 310.

Referring to FIG. 12, when a value M/L obtained by dividing a distance M between the first and second magnets 422 and 423 by a minimum value L of a width of the first protrusion 412 is equal to or greater than 1.5, a safety factor of the rotor 400 is less than 2.5. Hence, the safety factor standard is not satisfied. Therefore, the value M/L obtained by dividing the distance M between the first and second magnets 422 and 423 by the minimum value L of the width of the first protrusion 412 may be less than 1.5.

When the value M/L obtained by dividing the distance M between the first and second magnets 422 and 423 by the minimum value L of the width of the first protrusion 412 is equal to or less than 1.14, a back electromotive force of the motor 100 may rapidly decrease. Hence, the output of the motor 100 may be reduced. Therefore, the value M/L obtained by dividing the distance M between the first and second magnets 422 and 423 by the minimum value L of the width of the first protrusion 412 may be greater than 1.14. That is, the value M/L obtained by dividing the distance M between the first and second magnets 422 and 423 by the minimum value L of the width of the first protrusion 412 may be between 1.14 and 1.29.

When the value M/L obtained by dividing the distance M between the first and second magnets 422 and 423 by the minimum value L of the width of the first protrusion 412 is equal to or greater than 1.29, there is no significant change in an increase rate due to saturation of the back electromotive force of the motor 100, but the safety factor of the rotor 400 is greatly reduced. Therefore, the value M/L obtained by dividing the distance M between the first and second magnets 422 and 423 by the minimum value L of the width of the first protrusion 412 may be between 1.14 and 1.29. With this structure, the safety factor of the rotor 400 may be improved while improving the back electromotive force of the motor 100.

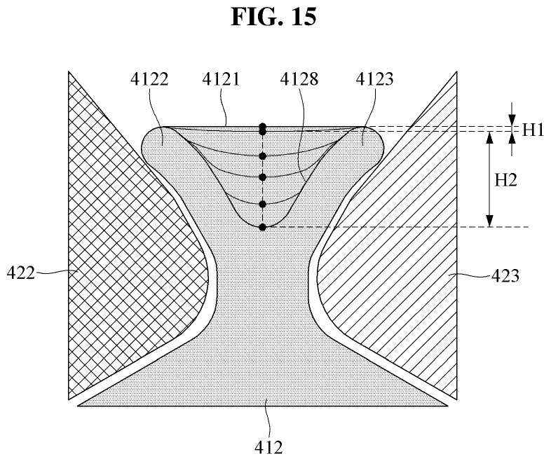

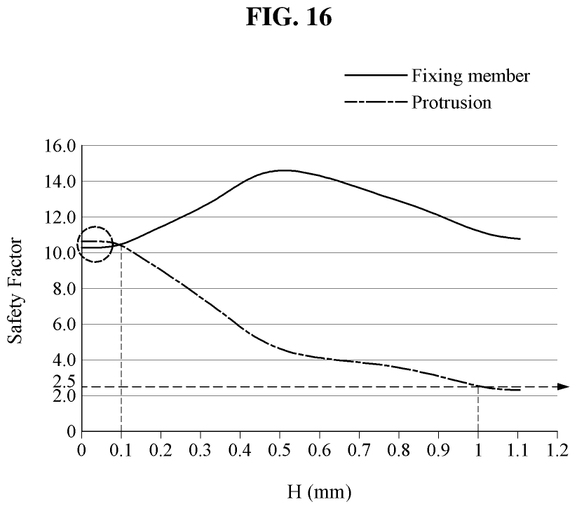

FIGS. 13 to 15 are cross-sectional views of a first protrusion and first and second magnets according to an embodiment. FIG. 16 is a graph illustrating a safety factor of a protrusion depending on a radial depth of a groove of the protrusion of a rotor core according to an embodiment.

Referring to FIGS. 13 to 15, the outer peripheral surface 4121, that is, a radially outer surface of the first protrusion 412 may include a groove 4128 that is radially inwardly concave. An axial cross section of the groove 4128 may have a curvature. The axial cross section of the groove 4128 may have at least two inflection points. With this structure, the safety factor of the fixing member 430 may be improved by increasing a radial length of the fixing member 430.

Referring to FIGS. 15 and 16, when radial depths H1 and H2 of the groove 4128 are equal to or greater than 0.1 mm, the safety factor of the first protrusion 412 may rapidly decrease. When the radial depths H1 and H2 of the groove 4128 are equal to or greater than 1 mm, the safety factor of the first protrusion 412 may be less than 2.5. Therefore, the safety factor standard is not satisfied. Hence, the radial depths H1 and H2 of the groove 4128 may be equal to or less than 1 mm. Further, the radial depths H1 and H2 of the groove 4128 may be equal to or less than 0.1 mm. With this structure, the safety factor of the protrusion 411 of the rotor 400 may be secured while securing the safety factor of the fixing member 430.

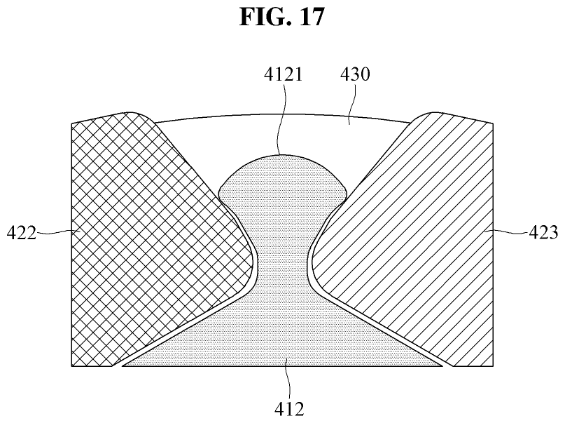

FIG. 17 is a cross-sectional view of a first protrusion and first and second magnets according to an embodiment. Referring to FIG. 17, the outer peripheral surface 4121 of the first protrusion 412 may be formed to be radially outwardly convex. With this structure, the safety factor of the first protrusion 412 may be improved.

Embodiments disclosed herein provide a compressor motor capable of reducing a motor excitation force and improving a back electromotive force and a compressor including a compressor motor.

Embodiments disclosed herein further provide a compressor motor capable of reducing manufacturing costs of a rotor and a compressor including a compressor motor.

Embodiments disclosed herein furthermore provide a compressor motor capable of compensating tolerance of a product and a compressor including a compressor motor.

Embodiments disclosed herein also provide a compressor motor capable of improving space efficiency of a rotor and a compressor including a compressor motor.

Embodiments disclosed herein provide a compressor motor capable of improving a safety factor of a rotor and a compressor including a compressor motor.

Embodiments disclosed herein additionally provide a compressor motor capable of preventing a reduction in an output of the motor by maintaining a constant gap between a magnet and a stator part, and a compressor including a compressor motor.

To achieve the above-described and other advantages, in one aspect according to an embodiment, there is provided a compressor motor comprising a stator and a rotor disposed inside of the stator and coupled to a shaft. The rotor may include a rotor core formed by axially stacking a plurality of magnetic steel plates and a plurality of magnets that is disposed on a radially outer surface of the rotor core and is spaced apart in a circumferential direction.

The rotor core may include a plurality of seating grooves in which the plurality of magnets is respectively seated, and a plurality of protrusions that protrudes radially outward between the plurality of seating grooves. The protrusion may include both side surfaces that extend radially outward and an outer peripheral surface that connects the both side surfaces in a circumferential direction. The magnet may include four surfaces that extend axially, and the four surfaces may include an inner surface that faces radially inward, an outer surface that is positioned opposite to the inner surface and faces an outer peripheral surface of the rotor, and two side surfaces that connect the inner surface and the outer surface.

The magnet may slide axially between adjacent protrusions of the plurality of protrusions, the inner surface of the magnet may be seated in the seating groove, and at least a portion of the side surface of the magnet may contact a side surface of the protrusion. The side surface of the magnet may extend and protrude further radially outward than the side surface of the protrusion, and a fixing member may be disposed in at least a partial area radially outward of the outer peripheral surface of the protrusion.

With this structure, the embodiments disclosed herein may reduce a motor excitation force and improve a back electromotive force. Further, the embodiments disclosed herein may secure reliability of the motor by preventing the magnet from being detached from the rotor. In addition, embodiments disclosed herein may reduce manufacturing costs of the rotor.

The fixing member may be disposed between side surfaces of adjacent magnets of the plurality of magnets, and radially further outward than the side surface of the protrusion. The side surface of the magnet and the protrusion may contact at one point. With this structure, the embodiments disclosed herein may prevent damage to the magnet generated during assembly of the rotor and improve ease of assembly of the rotor by minimizing a contact area between the magnet and the protrusion.

A distance between both side surfaces of the protrusion may gradually decrease as it goes radially inward from an area contacting at the one point, and an area between the side surface of the protrusion and the seating groove may be formed to be concave. At least one area of both side surfaces of the magnet may gradually increase as a distance between the both side surfaces goes radially inward, and an area between the inner surface of the magnet and the side surfaces of the magnet may be formed to be convex outward. A concave shape of the protrusion and a convex shape of the magnet may be shapes that complement each other.

The magnet and the protrusion may become far away from each other as they go radially inward from an area contacting at the one point. With this structure, the embodiments disclosed herein may improve ease of assembly of the magnet to the rotor and compensate for tolerance of the product.

An axial cross section of the magnet may have a trapezoidal shape, and an axial cross section of the protrusion may have an inverted trapezoidal shape. In this case, both ends in the circumferential direction of the outer peripheral surface of the protrusion may be formed to be convex outward in the circumferential direction, and the side surface of the magnet may contact a convex portion of the protrusion at one point. With this structure, the embodiments disclosed herein may implement one-point contact between the magnet and the protrusion.

A distance between both side surfaces of the protrusion may gradually decrease as the protrusion comes radially inward from the both ends in the circumferential direction. With this structure, the embodiments disclosed herein may improve space efficiency of the rotor.

The outer peripheral surface of the protrusion may include a groove that is concave radially inward. With this structure, the embodiments disclosed herein may improve a safety factor of the fixing member by increasing a radial length of the fixing member.

An axial cross section of the groove may have a curvature. In this case, the axial cross section of the groove may have at least two inflection points. A radially depth of the groove may be equal to or less than 0.1 mm. With this structure, the embodiments disclosed herein may secure a safety factor of the protrusion of the rotor while securing the safety factor of the fixing member.

The outer peripheral surface of the protrusion may be formed to be convex radially outward. With this structure, the embodiments disclosed herein may improve the safety factor of the protrusion.

An outer diameter of the fixing member may be greater than an outer diameter of the protrusion and less than an outer diameter of the magnet. With this structure, the embodiments disclosed herein may prevent a reduction in an output of the motor by maintaining a constant gap between the magnet and a stator part or portion.

A value obtained by dividing a distance between adjacent magnets of the plurality of magnets by a minimum value of a width of the protrusion may be between 1.14 and 1.29. With this structure, the embodiments disclosed herein may improve the safety factor of the rotor while improving a back electromotive force of the motor.

An outer surface of the fixing member may be formed to be convex radially outward. With this structure, the embodiments disclosed herein may improve the safety factor of the fixing member.

The fixing member may be injection molded with a resin material.

Embodiments disclosed herein further provide a compressor that may include a sealed container including a sealed space, a motor disposed in the sealed container and configured to generate a rotational force, and a compression unit configured to receive the rotational force of the motor and compress a refrigerant.

Embodiments disclosed herein provide a compressor motor capable of reducing a motor excitation force and improving a back electromotive force and a compressor including a compressor motor.

Embodiments disclosed herein provide a compressor motor capable of reducing manufacturing costs of a rotor and a compressor including a compressor motor.

Embodiments disclosed herein provide a compressor motor capable of compensating tolerance of a product and a compressor including a compressor motor.

Embodiments disclosed herein provide a compressor motor capable of improving space efficiency of a rotor and a compressor including a compressor motor.

Embodiments disclosed herein provide a compressor motor capable of improving a safety factor of a rotor and a compressor including a compressor motor.

Embodiments disclosed herein provide a compressor motor capable of preventing a reduction in an output of the motor by maintaining a constant gap between a magnet and a stator part, and a compressor including a compressor motor.

Embodiments described above are not exclusive or distinct from each other. Embodiments described above may be used together or combined in configuration or function.

For example, configuration “A” described in an embodiment and/or the drawings and configuration “B” described in another embodiment and/or the drawings may be combined with each other. That is, even if the combination between the configurations is not directly described, the combination is possible except in cases where it is described that it is impossible to combine.

The above detailed description is merely an example and is not to be considered as limiting. The scope should be determined by rational interpretation of the appended claims, and all variations within the equivalent scope are included in the scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A compressor motor for a compressor, the compressor motor comprising:
a stator; and
a rotor disposed inside of the stator and configured to be coupled to a shaft, wherein the rotor includes a rotor core comprising a plurality of axially stacked magnetic steel plates and a plurality of magnets disposed on a radially outer surface of the rotor core and spaced apart in a circumferential direction, wherein the rotor core further includes a plurality of seating grooves in which the plurality of magnets is respectively seated, and a plurality of protrusions that protrudes radially outward between the plurality of seating grooves, wherein each protrusion includes first and second side surfaces that extend radially outward and an outer peripheral surface that connects the first and second side surfaces in the circumferential direction, wherein each magnet includes four surfaces that extend axially, the four surfaces including an inner surface that faces radially inward, an outer surface that is positioned opposite to the inner surface, and first and second side surfaces that connect the inner surface and the outer surface, wherein the magnet slides axially between adjacent protrusions of the plurality of protrusions, the inner surface of the magnet is seated in the seating groove, and at least a portion of the side surface of the magnet contacts a side surface of the protrusion, and wherein the side surface of the magnet extends and protrudes further radially outward than the side surface of the protrusion, and a fixing member is disposed in at least a partial area radially outward of the outer peripheral surface of the protrusion.

2. The compressor motor of claim 1, wherein the fixing member is disposed, between side surfaces of adjacent magnets of the plurality of magnets, radially further outward than the side surface of the protrusion.

3. The compressor motor of claim 1, wherein the side surface of the magnet and the protrusion contact at one point.

4. The compressor motor of claim 3, wherein a distance between the side surfaces of the protrusion gradually decreases as the protrusion extends radially inward from an area contacting the side surface of the magnet at the one point, wherein an area between the side surface of the protrusion and the seating groove is concave, wherein at least one area of the side surfaces of the magnet gradually increases as the magnet extends radially inward, wherein an area between the inner surface of the magnet and the side surfaces of the magnet is outwardly convex, and wherein a concave shape of the protrusion and a convex shape of the magnet complement each other.

5. The compressor motor of claim 3, wherein the magnet and the protrusion become farther apart from each other as they extend radially inward from the area contacting at the one point.

6. The compressor motor of claim 1, wherein an axial cross section of the magnet has a trapezoidal shape, and wherein an axial cross section of the protrusion has an inverted trapezoidal shape.

7. The compressor motor of claim 3, wherein both ends in the circumferential direction of the outer peripheral surface of the protrusion are outwardly convex in the circumferential direction, and wherein the side surface of the magnet contacts a convex portion of the protrusion at one point.

8. The compressor motor of claim 7, wherein a distance between the side surfaces of the protrusion gradually decreases as the protrusion extends radially inward from both ends in the circumferential direction.

9. The compressor motor of claim 1, wherein the outer peripheral surface of the protrusion includes a groove that is radially inwardly concave.

10. The compressor motor of claim 9, wherein an axial cross section of the groove has a curvature.

11. The compressor motor of claim 10, wherein the axial cross section of the groove has at least two inflection points.

12. The compressor motor of claim 9, wherein a radial depth of the groove is equal to or less than 0.1 mm.

13. The compressor motor of claim 1, wherein the outer peripheral surface of the protrusion is radially outwardly convex.

14. The compressor motor of claim 1, wherein an outer diameter of the fixing member is greater than an outer diameter of the protrusion and is less than an outer diameter of the magnet.

15. The compressor motor of claim 1, wherein a value obtained by dividing a distance between adjacent magnets of the plurality of magnets by a minimum value of a width of the protrusion is between 1.14 and 1.29.

16. The compressor motor of claim 1, wherein an outer surface of the fixing member is radially outwardly convex.

17. The compressor motor of claim 1, wherein the fixing member is injection molded with a resin material.

18. A compressor, comprising:
a sealed container including a sealed space;
a motor disposed in the sealed container and configured to generate a rotational force; and
a compression unit configured to receive the rotational force of the motor and compress a refrigerant, wherein the motor is a compressor motor according to claim 1.

19. A compressor motor for a compressor, the compressor motor comprising:
a stator; and
a rotor disposed inside of the stator and configured to be coupled to a shaft, wherein the rotor includes a rotor core comprising a plurality of axially stacked magnetic steel plates and a plurality of magnets disposed on a radially outer surface of the rotor core and spaced apart in a circumferential direction, wherein the rotor core further includes a plurality of seating grooves in which the plurality of magnets is respectively seated, and a plurality of protrusions that protrudes radially outward between the plurality of seating grooves, wherein the plurality of magnets slides axially, respectively, between adjacent protrusions of the plurality of protrusions while seated in the plurality of seating grooves, and wherein a fixing member is disposed on an outer peripheral surface of the plurality of protrusions and extends between side surfaces of the plurality of magnets.

20. The compressor motor of claim 1, where the side surfaces of the plurality of magnets contact, respectively, side surfaces of the plurality of protrusions at one point.
